(19) United States
(12) Patent Application Publication
(10) Pub. No.: US 2018/0133849 A1
(43) Pub. Date: May 17, 2018

(54) TI-BASED FILLER ALLOY COMPOSITIONS

(71) Applicant: CASE WESTERN RESERVE UNIVERSITY, Cleveland, OH (US)

(72) Inventors: Dong Myoung Lee, Cleveland, OH (US); Gerhard E. Welsch, Cleveland, OH (US)

(21) Appl. No.: 14/784,167

(22) PCT Filed: Apr. 10, 2014
(86) PCT No.: PCT/US14/33666

§ 371 Date: Oct. 4, 2017

Related U.S. Application Data
(60) Provisional application No. 61/810,408, filed on Apr. 10, 2013.

(51) Int. Cl. B23K 35/32; C22C 14/00; C22C 30/02; B23K 35/02

(52) U.S. Cl. CPC B23K 35/325; C22C 14/00; B23K 2203/14; B23K 35/0233; B23K 35/0244; C22C 30/02

(57) ABSTRACT

Alloys comprising titanium as the principal component and which melt between 700 and 1400 degrees C. are disclosed to have favorable characteristics for braze-joining. The alloys form strong, corrosion-resistant braze-joints. They are useful for infiltration and formation of joints between components made of alloys and ceramics of similar and dissimilar compositions.

### RELATED APPLICATION

This application claims priority from U.S. Provisional Application No. 61/810,408, filed Apr. 10, 2013, the subject matter of which is incorporated herein by reference in its entirety.

### TECHNICAL FIELD

The present disclosure relates to a filler-alloy composition for brazing titanium, zirconium, and ceramic materials. For parts made of titanium and zirconium alloys, the filler-alloy can provide a robust joining medium with good corrosion resistance by wetting the surface of base materials and forming metallurgical bonds, e.g., by interdiffusion of filler-alloy elements with those of the base material. Through the active elements Ti and Zr, the filler-alloy can provide an excellent bonding reaction.

### BACKGROUND

Ternary and higher-order alloys based on titanium and zirconium with added melting-point-depressing elements, such as nickel or copper, and with ductility- and corrosion-resistance-enhancing elements have been recognized to be well suited for brazing titanium alloys, refractory metals and ceramics. Significant concentrations of reactive elements such as titanium and zirconium in the filler alloy makes bonding of ceramics and metals possible. Such filler alloy also enables the fabrication of quality braze-joined bodies of titanium-base material with excellent heat-resistance, corrosion resistance and strength at low and elevated temperatures.

For good braze-ability, the following attributes are desired for a filler-alloy: low melting temperature, wetting and bonding-reaction with the surface of the base material also alloy formation with the surface-layer of the base material, and high fluidity in the liquid state. These characteristics are beneficial for enhancing capillary traction of the melted filler-alloy in the gap between the base materials to be joined. Low-melting temperature is an important property for a filler-alloy because it saves energy and processing time during brazing or infiltration and is beneficial from the viewpoint of process engineering. Another important consideration for brazing titanium or titanium alloys is that the brazing process should be performed within a “temperature-window”. The lower end of this “temperature-window” is given by the minimum thermal energy needed to activate the reactions and processes of surface-wetting, bonding and diffusion and to enable them to take place in a reasonable time. The upper end of the temperature ‘window’ is recommended by the need to limit undesired side reactions, such as grain growth or phase transformations in the base metal and joint. In many titanium joining applications, the brazing temperature should be kept below the transus temperatures of the alloys to be joined in order to avoid or limit grain growth and unwanted phase transformations. Therefore, a low-melting filler-alloy is needed to enable braze-joining of titanium alloys below their transus temperatures.

Titanium and zirconium based filler-alloys are a good choice for joining base material parts of titanium or Ti-alloy because their compositions have similarity to those of the Ti- or Zr-based-base-materials. Pure and low-alloyed titanium and zirconium materials have high melting temperatures, usually well above the transus temperature of a structural titanium alloy, and are therefore not a good choice for the filler material. Cu and Ni alloy additions greatly decrease the melting temperatures of Ti and Zr. They are, therefore, added to Ti and Zr to form a lower-melting filler-alloy. However, when a Cu-rich or Ni-rich filler-alloy is used to braze a base material of titanium or titanium alloy the braze joint tends to develop undesired brittle intermetallic phases, such as TiₓCu_{y} and TiₓNi_{y}. It is therefore advisable to limit the concentrations of Cu and Ni in the filler-alloy to levels low enough to reduce the tendency of forming an intermetallic phase in the joint, yet high enough to impart the desired melting point depression.

### SUMMARY

The present disclosure relates to a Ti-rich low-melting filler alloy that can be used to join higher-melting Ti-base materials using a brazing temperature that remains below the transus temperature of the base materials. It also teaches to limit the concentrations of Ni and Cu in the filler-alloy to a level that minimizes or avoids possible formation of intermetallic TiₓCu_{y} and TiₓNi_{y} phases in the braze-joint but still enough to achieve a sufficiently low melting temperature of the filler-alloy to perform the brazing below the transus temperature of the base material to be brazed, e.g., below 880° C. when brazing pure titanium.

Other embodiments described herein relate to ternary (Ti—Zr—Ni) alloy systems that contain several different eutectic compositions. This opens opportunities for the discovery and development of a variety of low-melting filler alloys based on Ti and/or Zr. The ternary (Ti—Zr—Ni) system can be extended to quaternary systems, such as (Ti—Zr—Ni—Cu) and others, such as (Ti—Zr—S_{Ni}—S_{Cu}). This further broadens the range for the discovery of new low-melting eutectic alloys. Here, S_{Ni} is a substitute element for nickel that provides depression of the melting point, and S_{Cu} is a substitute element for copper that also provides depression of the melting point. The present disclosure describes the discovery and development of new low-melting eutectic alloys in the extended (Ti—Zr—Ni—Cu) and (Ti—Zr—S_{Ni}—S_{Cu}) systems and their benefit when used as a filler-alloy.

A ternary low-melting eutectic exists in the Ti-rich area of the (Ti—Zr—Ni) alloy system. The ternary eutectic is surrounded by binary eutectics of the quasi-binary Ti—Ti₂Ni and Ti₂Ni—(Ti,Zr)₂Ni systems. Through partial substitution of Ni with Cu, a new quaternary eutectic was discovered in the Ti-rich area of (Ti—Zr—Ni—Cu) with a melting temperature near 830° C. The present disclosure relates to the composition of this new quaternary eutectic alloy and the compositions of alloys in the vicinity around this quaternary eutectic point, and especially with compositions in the Ti-richer vicinity of this eutectic. Furthermore, additive elements such as Nb, Hf, Mo, W, V, Ta, Y, La and other rare-earth elements, Al, Fe, Cr, Mn, Be, and Co are effective in improving braze-ability by maintaining a low melting temperature and also contributing to the reactivity of the filler-alloy with the surface of the base material and contributing to the filler-alloy's fluidity in the liquid state. These additives, to be included in the alloys of the (Ti—Zr—Ni—Cu) system, are also discussed herein.

Consequently, the present disclosure enables brazing with a titanium-rich ternary or with a Ti-rich quaternary or with a Ti-rich higher-order filler-alloy at lower temperatures than is possible with prior-art Ti-rich braze-alloys. For example, using a Ti-rich filler-alloy of the present disclosure brazing can be accomplished at a temperature below 880° C. Such filler-alloy can also help in minimizing or avoiding the formation of undesired brittle intermetallic phases and associated loss of tensile strength in the braze-joints; it improves the mechanical strength and ductility properties of joints which are formed either by a single brazing cycle or by brazing with an additional heat-treating cycle.

In one embodiment, a braze alloy described herein can include a titanium-zirconium-nickel ternary composition having the formula:

TiₐZr_{b}Ni_{c} (Formula 1),
wherein a, b, and c are the atom % of, respectively, Ti, Zr, and Ni, and a is from about 47 to about 80, b is about 5 to about 25, and c is about 10 to about 33, and wherein 0.3<c(a+c)<0.35.

In one example, a is about 50 to about 70, b is about 10 to about 20, and c is about 20 to about 30. In another example, a is about 60, b is about 15, and c is about 25.

In some embodiments, the solidus temperature of the alloy composition is 841±2° C.

In another embodiment, the volume percent of a primary titanium phase ranges from 20% to 80%.

In another embodiment, a braze alloy described herein can include a titanium-zirconium-nickel-copper quaternary composition having the formula:

TiₐZr_{b}Ni_{c}Cu_{d} (Formula 2),
wherein a, b, c, and d are the atom % of, respectively, Ti, Zr, Ni and Cu, and a is from about 47 to about 80, b is about 5 to about 25, c+d is about 10 to about 33, d is greater than 0 and less than or equal to about 15, and wherein 0.12<d(c+d)<0.5.

In one example, a is about 50 to about 70, b is about 10 to about 20, c is about 13 to about 20, and a is about 7 to about 10. In another example, a is about 60, b is about 15, c is about 17, and d is about 8.

In some embodiments, the solidus temperature of the alloy composition is 830±2° C. In another embodiment, the volume percent of a primary titanium phase ranges from 20% to 80%.

In some embodiments, the braze alloys can further include up to 5% of an additive selected from the group consisting of Nb, Hf, Mo, W, V, Ta, Y, La, rare earth elements, Al, Ru, Pd, Fe, Cr, Mn, Co, Be, and mixtures thereof.

In still other embodiments, a braze alloy described herein can include a Ti—Zr—Ni-M alloy composition having the formula:

(TiₐZr_{b}Ni_{c})₁₀₀₀₋ₓMₓ (Formula 3),
wherein a, b, c, and x are the atom % of, respectively, Ti, Zr, Ni, and M, 0.20≤b/(a+b)≤0.45, 0.10≤c/(a+b+c)≤0.18, x is less than or equal to about 5, and M is an additive selected from the group consisting of Nb, Hf, Mo, W, V, Ta, Y, La, rare earth elements, Al, Ru, Pd, Fe, Cr, Mn, Co, Be, and mixtures thereof.

In yet other embodiments, a braze alloy described herein can include a Ti—Zr—Ni-M alloy composition having the formula:

(TiₐZr_{b}Ni_{c}Cu_{d})₁₀₀₋ₓMₓ (Formula 4),
wherein a, b, c, d, and x are the atom % of, respectively, Ti, Zr, Ni, Cu, and M, a is about 48 to about 60, b is about 20 to about 28, c+d is about 19 to about 30, d is about 3 to about 12, x is less than or equal to about 5, and M is an additive selected from the group consisting of Nb, Hf, Mo, W, V, Ta, Y, La, rare earth elements, Al, Ru, Pd, Fe, Cr, Mn, Co, Be, and mixtures thereof, and wherein 0.12<d/(c+d)<0.5.

Other embodiments described herein relate to a brazed construction that includes a plurality of individual parts and a brazed filler alloy joining the individual parts. The individual parts can be composed of at least one of titanium materials, zirconium materials, or ceramic materials. The filler alloy can include a ternary or quaternary eutectic composition The composition can include, by atom %, about 47% to about 80% titaninum, about 5% to about 25% zirconium, about 10% to about 33% nickel, and optionally copper. The copper when included in the composition can be substituted for nickel so that a combined amount of copper and nickel in the composition is about 10% to about 33%.

In some embodiments, the individual parts are composed of titanium alloys. In other embodiments at least one of individual parts is a ceramic material.

In one embodiment, a filler alloy of the brazed construction includes a titanium-zirconium-nickel ternary composition having the formula:

TiₐZr_{b}Ni_{c} (Formula 1),
wherein a, b, and c are the atom % of, respectively, Ti, Zr, and Ni, and a is from about 47 to about 80, b is about 5 to about 25, and c is about 10 to about 33, and wherein 0.3<c(a+c)<0.35.

In one example, a is about 50 to about 70, b is about 10 to about 20, and c is about 20 to about 30. In another example, a is about 60, b is about 15, and c is about 25.

In another embodiment, a filler alloy of the brazed construction includes a titanium-zirconium-nickel-copper quaternary composition having the formula:

TiₐZr_{b}Ni_{c}Cu_{d} (Formula 2),
wherein a, b, c, and d are the atom % of, respectively, Ti, Zr, Ni, and Cu, and a is from about 47 to about 80, b is about 5 to about 25, c+d is about 10 to about 33, d is greater than 0 and less than or equal to about 15, and wherein 0.12<d(c+d)<0.5.

In one example, a is about 50 to about 70, b is about 10 to about 20, c is about 13 to about 20, and d is about 7 to about 10. In another example, a is about 60, b is about 15, c is about 17, and d is about 8.

In some embodiments, the filler alloy for the brazed construction can further include up to 5% of an additive, the additive being selected from the group consisting of Nb, Hf, Mo, W, V, Ta, Y, La, rare earth elements, Al, Ru, Pd, Fe, Cr, Mn, Co, Be, and mixtures thereof.

In still other embodiments, a filler alloy for the brazed construction can include a Ti—Zr—Ni-M alloy composition having the formula:

(TiₐZr_{b}Ni_{c})₁₀₀₋ₓMₓ (Formula 3),
wherein a, b, c, and x are the atom % of, respectively, Ti, Zr, Ni, and M, 0.20≤b/(a+b)≤0.45, 0.10≤c/(a+b+c)≤0.18, x is less than or equal to about 5, and, M is an additive selected from the group consisting of Nb, Hf, Mo, W, V, Ta, Y, La, rare earth elements, Al, Ru, Pd, Fe, Cr, Mn, Co, Be, and mixtures thereof.

In yet other embodiments, the filler alloy for the brazed construction can include a Ti—Zr—Ni-M alloy composition having the formula:

(TiₐZr_{b}Ni_{c}Cu_{d})₁₀₀₋ₓMₓ (Formula 4),
wherein a, b, c, d, and x are the atom % of, respectively, Ti, Zr, Ni, Cu, and M, a is about 48 to about 60, b is about 20 to about 28, c+d is about 19 to about 30, d is about 3 to about 12, x is less than or equal to about 5, and M is an additive selected from the group consisting of Nb, Hf, Mo, W, V, Ta, Y, La, rare earth elements, Al, Ru, Pd, Fe, Cr, Mn, Co, Be, and mixtures thereof, wherein 0.12<d/(c+d)<0.5.

### DESCRIPTION OF FIGURES

FIG. 1 is a representation of the differential thermal analysis (DTA) scans of two Ti-rich braze- or filler-alloys: one DTA scan is of the ternary Ti₆₀Zr₁₅Ni₂₅ alloy; the other is a DTA scan of the Ti₆₀Zr₁₅Ni₁₇Cu₈ alloy. The scan features show the onset of melting (solidus temperature) and the end of melting (liquidus temperature) during heating and cooling cycles.

### DETAILED DESCRIPTION

When introducing elements of various embodiments of the present invention, the articles “a,” “an,” “the,” and “said” are intended to mean that there are one or more of the elements, unless otherwise indicated. The terms “comprising,” “including,” and “having” are intended to be inclusive, and mean that there may be additional elements other than the listed elements. As used herein, the term “and/or” includes any and all combinations of one or more of the associated listed items.

Approximating language, as used herein throughout the specification and claims, may be applied to modify any quantitative representation that could permissibly vary without resulting in a change in the basic function to which it may be related. Accordingly, a value modified by a term such as “about” is not limited to the precise value specified. In some instances, the approximating language may correspond to the precision of an instrument for measuring the value.

As used herein, the term “liquidus temperature” generally refers to a temperature at which an alloy is transformed from a solid into a molten or viscous state. The liquidus temperature specifies the maximum temperature at which crystals can co-exist with the melt in thermodynamic equilibrium. Above the liquidus temperature, the alloy is homogeneous, and below the liquidus temperature, more and more crystals begin to form in the melt with time, depending on the alloy. Generally, an alloy, at its liquidus temperature, melts and forms a seal between two components to be joined.

The liquidus temperature can be contrasted with a “solidus temperature”. The solidus temperature quantifies the point at which a material completely solidifies (crystallizes). The liquidus and solidus temperatures do not necessarily align or overlap. If a gap exists between the liquidus and solidus temperatures, then within that gap, the material consists of solid and liquid phases simultaneously (like a “slurry”).

“Sealing” is a function performed by a structure that joins other structures together, to reduce or prevent leakage through the joint, between the other structures. The seal structure may also be referred to as a “seal.”

Typically, “brazing” uses a braze material (usually an alloy) having a lower liquidus temperature than the melting points of the components (i.e. their materials) to be joined. The braze material is brought slightly above its melting (or liquidus) temperature while protected by a suitable atmosphere. The braze material then flows over the components (known as wetting), and is then cooled to join the components together. As used herein, “braze alloy composition” or “braze alloy”, “braze material” or “brazing alloy”, refers to a composition that has the ability to wet the components to be joined, and to seal them. A braze alloy, for a particular application, should withstand the service conditions required, and melts at a lower temperature than the base materials; or melts at a very specific temperature.

As used herein, the term “brazing temperature” refers to a temperature to which a brazing structure is heated to enable a braze alloy to wet the components to be joined, and to form a braze joint or seal. The brazing temperature is often higher than or equal to the liquidus temperature of the braze alloy. In addition, the brazing temperature should be lower than the temperature at which the components to be joined may not remain chemically, compositionally, and mechanically stable. There may be several other factors that influence the brazing temperature selection, as those skilled in the art understand.

Embodiments described herein relate to braze-alloys, which are particularly well suited as filler-alloys for joining higher-melting titanium and titanium alloys as well as ceramics. The braze alloys can be provided in the form of a powder or foil and used to join titanium, zirconium, and/or ceramic parts to form a brazed construction.

Titanium is the principal component, e.g., Ti constitutes 47 to 52 atom percent of the filler-alloy. Zirconium is another principal component but with a lower concentration than titanium. Other elements are added to the alloy in a melting process prior to any brazing operation in such proportions as needed to achieve the desired decrease of the alloy's liquidus and solidus temperatures as would be encountered during cooling and solidification of a homogenized melt of the braze-alloy. These other elements are designated “type I” alloy elements.

Nickel and copper elements are representative type I alloy elements. They are added as components to the principal components titanium and zirconium. A low-melting ternary composition exists in the Ti-rich area of the Ti—Zr—Ni system forming a eutectic alloy. The composition of this eutectic is Ti₆₀Zr₁₅Ni₂₅. Its melting temperature is 841±2° C. To decrease the melting temperature of the Ti₆₀Zr₁₅Ni₂₅ alloy further, copper can be added or substituted for some of the Ni in the alloy. Cu addition/substitution was found to be effective to further decrease the alloy's melting temperature by about 10° C. to approximately 831±2° C.

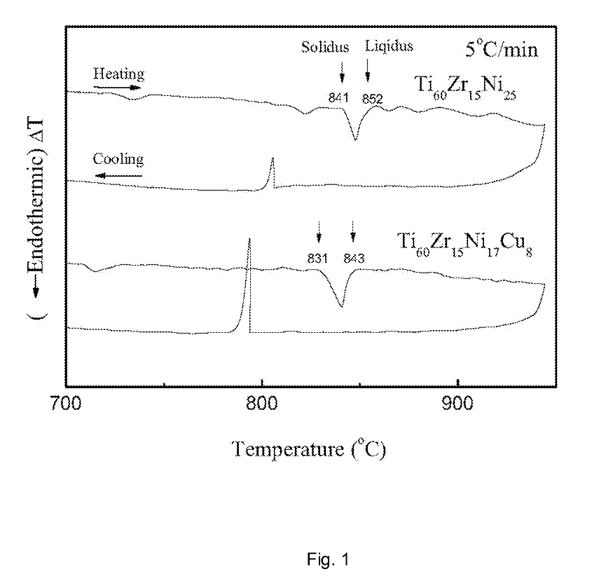

The lowest melting temperature was found for an alloy of the composition Ti₆₀Zr₁₅Ni₁₇Cu₈. The solidus and liquidus temperatures of this alloy are 831° C. and 843° C., respectively, as measured by differential thermal analysis (DTA), FIG. 1. This solidus temperature is lowest for alloys in the Ti-rich region of the Ti—Zr—Ni—Cu system. Other alloy compositions in the vicinity around the Ti₆₀Zr₁₅Ni₁₇Cu₈ composition have liquidus temperatures above 841° C., but have the same low solidus temperature of 831° C. These alloy compositions, listed in Examples 4, 5, 6 in Table 1, can be excellent filler-alloys because of their low solidus temperature.

Comparative study results are shown in Table 1. The comparison alloy 1 containing 35% nickel and the comparison alloy 2 containing 35% of combined nickel+copper have higher solidus temperatures than the ternary and quaternary alloys described in the present disclosure. When the concentrations of nickel+copper or of nickel alone exceed 33 atom %, the alloys belong to a higher-melting portion of the Ti—Zr—Ni(Cu) system and are different in their final phase-composition from the ternary and quaternary eutectic alloys containing less than 33% of nickel+copper or of nickel alone. Therefore, the present disclosure limits the concentration of nickel+copper or of nickel alone to less than 33%. The comparison alloys 3 and 4 are prior art commercial filler-alloys. These comparison alloys have a higher solidus temperature than the alloys of the present disclosure. They contain copper concentrations above 12 atom % and form copper-containing intermetallic compounds which is detrimental to the mechanical strength and corrosion resistance of a braze joint. Therefore, the present disclosure limits the concentration of copper to less than 12 atom percent.

TABLE 1
Exemplar filler-alloys and comparison alloys

| Filler Alloy Compositions | | | | | Solidus | Liquidus | |
|---|---|---|---|---|---|---|---|
| [atom percent] | | | | | Temperatures | Temperature | |
| Alloy | Ti | Zr | Ni | Cu | [° C.] | [° C.] | Comments |
| Exemplar 1 | 70 | 10 | 20 | — | 841 | 1020 | Example embodiment |
| Exemplar 2 | 60 | 15 | 25 | — | 841 | 852 | Example embodiment |
| Exemplar 3 | 50 | 20 | 30 | — | 841 | 910 | Example embodiment |
| Comparison 1 | 50 | 15 | 35 | — | 870 | 930 | Example embodiment |
| Exemplar 4 | 70 | 10 | 13 | 7 | 831 | 855 | Example embodiment |
| Exemplar 5 | 60 | 15 | 17 | 8 | 831 | 843 | Example embodiment |
| Exemplar 6 | 50 | 20 | 20 | 10 | 831 | 875 | Example embodiment |
| Comparison 2 | 50 | 15 | 23 | 12 | 850 | 890 | Example embodiment |
| Comparison 3 | 49 | 26 | 10 | 15 | 840 | 858 | Prior Art |
| Comparison 4 | 75 | — | 13 | 12 | 901 | 933 | Prior Art |

TABLE 2
Examples of Base Material

| | | Transus | Solidus | Liquidus |
|---|---|---|---|---|
| Commercial Grade Base Alloys and Compositions | | Temperature | Temperature | Temperature |
| [weight percent] | | [° C.] | [° C.] | [° C.] |
| Ti - grade 1 | Balance Ti, max 0.13[O] | 880 +/− 2 | 1666 | 1667 |
| Ti - grade 2 | Balance Ti, max. 0.2Fe max. 0.20[O] | 890 +/− 5 | 1667 | 1668 |
| Ti - grade 23 | Balance Ti—6A1—4V, max. 0.25[Fe], | 995 +/− 5 | 1605 | 1660 |
| | max. 0.20[O[ | | | |
| Ti - grade 5 | Balance Ti—6A1—2Sn—4Zr—2Mo | 1000 +/− 5 | 1605 | 1660 |

Other alloy elements, designated “type II”, are added to stabilize solid phases that are plastically deformable. These can be solid-solution phases or intermetallic phases with high crystal symmetry or they can be a glassy phase with some plastic formability, e.g., by creep-deformation. Small amounts of type II elements Al, Be, Hf, Nb, Ta, Y, La and other rare-earth elements (RE's) improve the ability of forming a titanium-based metallic glass. The addition of type II elements contributes to plastic deformability of crystalline phases or of glassy phases formed in a braze joint after solidification.

Other alloy elements, Mo, W, V, Cr, Mn, Ru, and Pd, are designated “type III”. They are added in order to enhance desirable properties such as the fluidity of the melted braze alloy, and/or the corrosion/oxidation resistance of the finished brazed product, and/or to modify the thermophysical properties of the braze alloy, such as elastic modulus and thermal expansion coefficient, to shift them closer to those of the base material.

In some embodiments, a filler-alloy that comprises titanium and zirconium and other added elements that enable the tailoring of the alloy's physical, thermophysical, chemical and mechanical properties. Additive elements such as Nb, Hf, Mo, W, V, Ta, Y, La and other rare-earth elements, Al, Fe, Cr, Mn, Be, and Co improve the braze-ability of the Ti-rich near-eutectic alloys in the Ti—Zr—Ni—Cu system. Additive elements such as Nb, Hf, Mo, W, V, Ta, Y, Al, Ru and Pd enhance the corrosion resistance of the braze joint. Additive elements such as Al, Fe, Cr, Mn, Co and Be decrease the melting temperature and improve the fluidity of liquid filler alloy and the wetting of base materials by the filler alloy.

The type II and type III additive elements included in the Ti-rich Ti—Zr—Ni(Cu) braze-alloys amount to less than 5 atom % in total.

The main phases of the ternary and quaternary eutectic alloys in the present disclosure are alpha or beta Ti-solid-solution(s) and Ti₂Ni and (Ti,Zr)₂Ni intermetallics. When the nickel or nickel+copper concentrations in the filler-alloy are less than 25 atom %, they form off-eutectics in the titanium-rich area of the Ti—Zr—Ni(Cu) system and form primarily an alpha-titanium solid-solution-phase upon solidification. This solid-solution phase is more ductile and mechanically stronger than the intermetallic Ti₂Ni and (Ti,Zr)₂Ni phases which are brittle. Because the solid-solution phase, such as the alpha-phase, is distributed in a significant volume fraction throughout a solidified off-eutectic alloy of the titanium-rich ternary and/or quaternary system, the off-eutectic alloys exhibit better mechanical strength than the eutectic alloy. When the volume fraction of alpha-titanium-phase is greater than 20% and as high as 80 percent, the tensile strength of the solidified filler alloy will be in the range from 100 MPa to 600 MPa and sometimes higher.

A disadvantage of an off-eutectic braze alloy is its higher liquidus temperature than that of the near-eutectic alloys. However, the solidus temperature is the same as that of the near-eutectic, namely TS=841° C. for an off-eutectic ternary Ti—Zr—Ni alloy and 831° C. for a quaternary off-eutectic Ti—Zr—Ni—Cu alloy. The advantage of the solidified off-eutectic alloys is their higher strength attributable to their content of ductile alpha solid-solution-phase and minimization of intermetallic phases. The Ti-rich off-eutectic braze-alloys are useful because they can form strong braze joints without the need of a post-treatment. They can be used to join unalloyed titanium and zirconium base materials as well as Ti and Zr-alloy parts and to join ceramic to ceramic and ceramic to metal.

Therefore, in some embodiments, the off-eutectic braze alloys of compositions and phases on the Ti-rich side of the Ti—Zr—Ni(Cu) system with and without type II and type III additive elements.

The near-eutectic alloys on the Ti-rich side of the ternary and quaternary alloy systems have the advantage of a low solidus temperature and liquidus temperature. However, they have the disadvantage of frequently ending up with brittle intermetallic phases after cooling to room temperature. This disadvantage can be cured by a post-treatment that promotes interdiffusion and metallic bonding between the base and filler alloy(s). In such circumstance, the titanium or zirconium base alloy parts are brazed with a near-eutectic filler-alloy at a temperature below the base-alloy's transus. Optionally, they can be held for a time at temperature during which the alloy elements of the filler alloy can exchange by diffusion with the elements of the base material. This will generally lead to a dilution of nickel and/or copper concentrations in the joint and to transformation of possible intermetallic phases to more ductile alpha-titanium or alpha-zirconium solid-solution phases.

In other embodiments, the eutectic and near-eutectic braze alloys Ti₆₀Zr₁₅Ni₂₅ and Ti₆₀Zr₁₅Ni₁₇Cu₈ as well as the Ti-rich alloys in the vicinity of the indicated eutectics with and without type II and type III additive elements. The near-eutectic alloys can be used to braze titanium and zirconium with good strength when used in conjunction with an optional diffusion heat treatment.

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

Having described the invention, the following is claimed:

1. A braze alloy comprising: a ternary or quaternary eutectic composition, the composition including, by atom %, about 47% to about 80% titaninum, about 5% to about 25% zirconium, about 10% to about 33% nickel, and optionally copper, wherein the copper when included in the composition is substituted for nickel so that a combined amount of copper and nickel in the composition is about 10% to about 33%.

2. The braze alloy of claim 1, having a liquidus temperature below 880° C.

3. The braze alloy of claim 1, wherein the volume percent of primary titanium phase is from about 20% to about 80%.

4. The braze alloy of claim 1, being in a foil form.

5. The braze alloy of claim 1, being in a powder form.

6. The braze alloy of claim 1, comprising a titanium-zirconium-nickel ternary composition having the formula:
TiₐZr_{b}Ni_{c},
wherein a, b, and c are the atom % of, respectively, Ti, Zr, and Ni, and a is about 47 to about 80, b is about 5 to about 25, and c is about 10 to about 33.

7. The braze alloy of claim 6, wherein 0.3<c(a+c)<0.35.

8. The braze alloy of claim 6, wherein a is about 50 to about 70, b is about 10 to about 20, and c is about 20 to about 30.

9. The braze alloy of claim 6, wherein a is about 60, b is about 15, and c is about 25.

10. The braze alloy of claim 1, comprising a titanium-zirconium-nickel-copper quaternary composition having the formula:
TiₐZr_{b}Ni_{c}Cu_{d},
wherein a, b, c, and d are the atom % of, respectively, Ti, Zr, Ni, and Cu, and a is about 47 to about 80, b is about 5 to about 25, c+d is about 10 to about 33, d is greater than 0 and less than or equal to about 15.

11. The braze alloy of claim 10, wherein 0.12<d(c+d)<0.5.

12. The braze alloy of claim 10, wherein a is about 50 to about 70, b is about 10 to about 20, c is about 13 to about 20, and d is about 7 to about 10.

13. The braze alloy of claim 10, wherein a is about 60, b is about 15, and c is about 17, and d is about 8.

14. The braze alloy of claim 1, further comprising up to 5% of an additive, the additive being selected from the group consisting of Nb, Hf, Mo, W, V, Ta, Y, La, rare earth elements, Al, Ru, Pd, Fe, Cr, Mn, Co, Be, and mixtures thereof.

15. The braze alloy of claim 1, comprising a Ti—Zr—Ni-M alloy composition having the formula:
(TiₐZr_{b}Ni_{c})₁₀₀₋ₓMₓ,
wherein a, b, c, and x are the atom % of, respectively, Ti, Zr, Ni, and M, 0.20≤b/(a+b)≤0.45, 0.10≤c/(a+b+c)≤0.18, x is less than or equal to about 5, and M is an additive selected from the group consisting of Nb, Hf, Mo, W, V, Ta, Y, La, rare earth elements, Al, Ru, Pd, Fe, Cr, Mn, Co, Be, and mixtures thereof.

16. The braze alloy of claim 1, comprising a Ti—Zr—Ni-M alloy composition having the formula:
(TiₐZr_{b}Ni_{c}Cu_{d})₁₀₀₋ₓMₓ,
wherein a, b, c, d, and x are the atom % of, respectively, Ti, Zr, Ni, Cu, and M, a is about 48 to about 60, b is about 20 to about 28, c+d is about 19 to about 30, d is about 3 to about 12, x is less than or equal to about 5, and M is an additive selected from the group consisting of Nb, Hf, Mo, W, V, Ta, Y, La, rare earth elements, Al, Ru, Pd, Fe, Cr, Mn, Co, Be, and mixtures thereof.

17. The braze alloy of claim 16, wherein 0.12<d/(c+d)<0.5.

18. A braze alloy comprising: a titanium-zirconium-nickel ternary composition having the formula:
TiₐZr_{b}Ni_{c},
wherein a, b, and c are the atom % of, respectively, Ti, Zr, and Ni, and a is about 47 to about 80, b is about 5 to about 25, and c is about 10 to about 33.

19. The braze alloy of claim 18, wherein 0.3<c(a+c)<0.35.

20. The braze alloy of claim 18, having a liquidus temperature below 880° C.

21. The braze alloy of claim 18, wherein the volume percent of primary titanium phase is from about 20% to about 80%.

22. The braze alloy of claim 18, wherein a is about 50 to about 70, b is about 10 to about 20, and c is about 20 to about 30.

23. The braze alloy of claim 18, wherein a is about 60, b is about 15, and c is about 25.

24. The braze alloy of claim 18, being in a foil form.

25. The braze alloy of claim 18, being in a powder form.

26. A braze alloy comprising: a titanium-zirconium-nickel-copper quaternary composition having the formula:
TiₐZr_{b}Ni_{c}Cu_{d},
wherein a, b, c, and d are the atom % of, respectively, Ti, Zr, Ni, and Cu, and a is about 47 to about 80, b is about 5 to about 25, c+d is about 10 to about 33, d is greater than 0 and less than or equal to 15.

27. The braze alloy of claim 26, wherein 0.12<d(c+d)<0.5.

28. The braze alloy of claim 26, having a liquidus temperature below 880° C.

29. The braze alloy of claim 26, wherein the volume percent of primary titanium phase is from about 20% to about 80%.

30. The braze alloy of claim 26, wherein a is about 50 to about 70, b is about 10 to about 20, c is about 13 to about 20, and d is about 7 to about 10.

31. The braze alloy of claim 26, wherein a is about 60, b is about 15, c is about 17, and d is about 8.

32. The braze alloy of claim 26, being in a foil form.

33. The braze alloy of claim 26, being in a powder form.

34. A braze alloy comprising: a Ti—Zr—Ni-M alloy composition having the formula:
(TiₐZr_{b}Ni_{c})₁₀₀₋ₓMₓ,
wherein a, b, c, and x are the atom % of, respectively, Ti, Zr, Ni, and M, 0.20≤b/(a+b)≤0.45, 0.10≤c/(a+b+c)≤0.18, x is less than or equal to about 5, and M is an additive selected from the group consisting of Nb, Hf, Mo, W, V, Ta, Y, La, rare earth elements, Al, Ru, Pd, Fe, Cr, Mn, Co, Be, and mixtures thereof.

35. A braze alloy comprising: a Ti—Zr—Ni-M alloy composition having the formula:
(TiₐZr_{b}Ni_{c}Cu_{d})₁₀₀₋ₓMₓ,
wherein a, b, c, d, and x are the atom % of, respectively, Ti, Zr, Ni, Cu, and M, a is about 48 to about 60, b is about 20 to about 28, c+d is about 19 to about 30, d is about 3 to about 12, x is less than or equal to about 5, and M is an additive selected from the group consisting of Nb, Hf, Mo, W, V, Ta, Y, La, rare earth elements, Al, Ru, Pd, Fe, Cr, Mn, Co, Be, and mixtures thereof.

36. The braze alloy of claim 35, wherein 0.12<d/(c+d)<0.5.

37. A brazed construction comprising a plurality of individual parts and a brazed filler alloy joining the individual parts, wherein the individual parts are composed of at least one of titanium materials, zirconium materials, or ceramic materials, and the filler alloy includes a ternary or quaternary eutectic composition, the composition including, by atom %, about 47% to about 80% titaninum, about 5% to about 25% zirconium, about 10% to about 33% nickel, and optionally copper, wherein the copper when included in the composition is substituted for nickel so that a combined amount of copper and nickel in the composition is about 10% to about 33%.

38. The brazed construction of claim 37, wherein the individual parts are composed of titanium alloys.

39. The brazed construction of claim 37, wherein in at least one of individual parts is a ceramic material.

40. The brazed construction of claim 37, the filler alloy having a liquidus temperature below 880° C.

41. The brazed construction of claim 37, wherein the volume percent of primary titanium phase of the filler alloy is from about 20% to about 80%.

42. The brazed construction of claim 37, wherein the filler alloy comprises a titanium-zirconium-nickel ternary composition having the formula:
TiₐZr_{b}Ni_{c},
wherein a, b, and c are the atom % of, respectively, Ti, Zr, and Ni, and a is about 47 to about 80, b is about 5 to about 25, and c is about 10 to about 33.

43. The brazed construction of claim 42, wherein 0.3<c(a+c)<0.35.

44. The brazed construction of claim 42, wherein a is about 50 to about 70, b is about 10 to about 20, and c is about 20 to about 30.

45. The brazed construction of claim 42, wherein a is about 60, b is about 15, and c is about 25.

46. The brazed construction of claim 37, the filler alloy comprising a titanium-zirconium-nickel-copper quaternary composition having the formula:
TiₐZr_{b}Ni_{c}Cu_{d},
wherein a, b, c, and d are the atom % of, respectively, Ti, Zr, Ni, and Cu, and a is about 47 to about 80, b is about 5 to about 25, c+d is about 10 to about 33, d is greater than 0 and less than or equal to 15.

47. The brazed construction of claim 46, wherein 0.12<d(c+d)<0.5.

48. The brazed construction of claim 46, wherein a is about 50 to about 70, b is about 10 to about 20, c is about 13 to about 20, and d is about 7 to about 10.

49. The brazed construction of claim 46, wherein a is about 60, b is about 15, c is about 17, and d is about 8.

50. The brazed construction of claim 37, the filler alloy further comprising up to 5% of an additive selected from the group consisting of Nb, Hf, Mo, W, V, Ta, Y, La, rare earth elements, Al, Ru, Pd, Fe, Cr, Mn, Co, Be, and mixtures thereof.

51. The brazed construction of claim 37, the filler alloy comprising a Ti—Zr—Ni-M alloy composition having the formula:
(TiₐZr_{b}Ni_{c})₁₀₀₋ₓMₓ,
wherein a, b, c, and x are the atom % of, respectively, Ti, Zr, Ni, and M, 0.20≤b/(a+b)≤0.45, 0.10≤c/(a+b+c)≤0.18, x is less than or equal to about 5, M is an additive selected from the group consisting of Nb, Hf, Mo, W, V, Ta, Y, La, rare earth elements, Al, Ru, Pd, Fe, Cr, Mn, Co, Be, and mixtures thereof.

52. The brazed construction of claim 37, the filler alloy comprising a Ti—Zr—Ni-M alloy composition having the formula:
(TiₐZr_{b}Ni_{c}Cu_{d})₁₀₀₋ₓMₓ,
wherein a, b, c, d, and x are the atom % of, respectively, Ti, Zr, Ni, Cu, and M, a is about 48 to about 60, b is about 20 to about 28, c+d is about 19 to about 30, d is about 3 to about 12, x is less than or equal to about 5, M is an additive selected from the group consisting of Nb, Hf, Mo, W, V, Ta, Y, La, rare earth elements, Al, Ru, Pd, Fe, Cr, Mn, Co, Be, and mixtures thereof.

53. The brazed construction of claim 52, wherein 0.12<d/(c+d)<0.5.
